(19) United States
(12) Patent Application Publication
(10) Pub. No.: US 2007/0297935 A1
(43) Pub. Date: Dec. 27, 2007

(54) Stir processed cast aluminum-scandium structures and methods of making the same

(76) Inventors: Timothy Langan, Catonsville, MD (US); Michael A. Riley, Towson, MD (US); W. Mark Buchta, Ellicott City, MD (US)

Correspondence Address: PIETRAGALLO, BOSICK & GORDON LLP, ONE OXFORD CENTRE, 38TH FLOOR, 301 GRANT STREET, PITTSBURGH, PA, 15219-6404, US

(21) Appl. No.: 11/701,836

(22) Filed: Feb. 2, 2007

Related U.S. Application Data
(60) Provisional application No. 60/764,463, filed on Feb. 2, 2006.

(51) Int. Cl. C22C 21/00; C01F 7/00; C22F 1/04

(52) U.S. Cl. 420/528; 148/523; 423/124

(57) ABSTRACT

Friction stir processing is applied to an aluminum-scandium alloy workpiece in either a wrought or cast state including scandium-containing precipitates. The process selectively modifies the microstructure of the aluminum-scandium workpiece, for example, by reducing grain size and recrystallization of the substrate. Benefits include increased physical properties of the aluminum-scandium alloys as well as the ability to form unique alloy structures.

### CROSS-REFERENCE TO RELATED APPLICATION

This application claims the benefit of U.S. Provisional Patent Application Ser. No. 60/764,463 filed Feb. 2, 2006, which is incorporated herein by reference.

### FIELD OF THE INVENTION

The present invention utilizes the friction stir process to modify the grain structure of bulk cast or wrought aluminum-scandium alloys, thereby enhancing mechanical properties of such alloys.

### BACKGROUND INFORMATION

Casting processes provide an economical approach for direct fabrication of net shaped parts, but properties of cast aluminum alloy structures do not typically attain the same level as those observed in wrought structures. Workers have improved properties of cast materials by modifying strengthening precipitates, reducing flaws, e.g., pores, and controlling grain structure during solidification.

Friction processing of metals has been practiced for a number of years. The first engineering applications involved joining two parts by spinning one into another. For example, tubes were joined to the stock head through inertial welding. Work by Thomas et al. at The Welding Institute in England showed that a rotating tool can be used to essentially “whip” two pieces of metal together. U.S. Pat. No. 5,460,317 to Thomas et al. discloses such a process, which is known as friction stir welding and is currently seeing commercial applications world wide. U.S. Pat. No. 6,712,916 to Mishra et al. discloses that the friction stir process can be used to produce aluminum alloys that can be superplastically formed.

### SUMMARY OF THE INVENTION

The present invention utilizes a mechanical stirring process to refine the grain structure in aluminum-scandium alloys. The stir process refines the microstructure forming ultra fine equiaxed grains, or nano-grains, within the aluminum alloy structure. The aluminum alloy may comprise a conventional wrought Al-Sc alloy composition which may be cast and subjected to the mechanical stirring process to provide a wrought microstructure without the necessity of conventional working processes such as extrusion, rolling, forging, etc. Typical wrought aluminum-scandium alloy compositions that may be mechanically stirred include conventional 2XXX, 5XXX, 6XXX, 7XXX and Al-Li alloys with scandium additions. The resulting refined grain structure may provide superior mechanical properties, corrosion resistance and ballistic performance.

An aspect of the present invention is to provide a method of treating an Al alloy substrate, the method comprising: thermally aging an Al alloy substrate comprising Sc to form Sc-containing precipitates in the Al alloy substrate; plunging a rotating tool into a surface of the Al alloy substrate and translating the Al alloy substrate with respect to the rotating tool to produce a friction stirred zone over at least a portion of the surface of the Al alloy substrate; and heat treating and aging the Al alloy substrate.

Another aspect of the present invention is to provide a method of treating a cast Al alloy substrate, the method comprising: providing a cast Al alloy substrate comprising Sc-containing precipitates therein; plunging a rotating tool into a surface of the Al alloy substrate and translating the Al alloy substrate with respect to the rotating tool to produce a friction stirred zone over at least a portion of the surface of the Al alloy substrate; and heat treating and aging the Al alloy substrate.

A further aspect of the present invention is to provide an aluminum-scandium alloy substrate comprising a thermally aged and friction stirred zone over at least a portion of a surface of the aluminum-scandium alloy substrate.

Another aspect of the invention is to provide modify the composition of cast aluminum-scandium alloys to optimize the refinement associated with the stir processing. Scandium added to conventional wrought aluminum alloy base compositions reduces or eliminates recrystallization.

A further aspect of the invention is to provide a process that can be used to modify sections cut from aluminum-scandium castings or can be used to modify net shaped or near net shaped castings. In addition, the process can be used to selectively modify specific regions on or in castings. While a cast aluminum-scandium structure represents the lowest cost and lowest strength condition of an aluminum alloy part, similar applications can be accomplished in pre-wrought alloys as well, such as extrusions, forgings and rolled aluminum-scandium alloys.

Another aspect of the invention is to use the stir process to mix particles into a surface layer on a wrought or cast aluminum-scandium substrate. Suitable particles include refractory, ceramic, intermetallic and lubricious particles. Among other possible applications, this processing can provide hard wear resistant layers, corrosion resistant layers or layers with specific thermal properties that are mechanically bonded to the surface.

A further aspect of the invention is to form a composite aluminum based structure by mixing a second phase material into the bulk of a cast or wrought aluminum-scandium article. This aspect of the invention can be used to form aluminum-scandium based metal-matrix composites (MMCs) with superior hardness, strength and/or modulus, among other desirable properties.

These and other aspects of the present invention will be more apparent from the following description.

### BRIEF DESCRIPTION OF THE DRAWINGS

FIG. 1 is a side sectional view of a thermally aged aluminum-scandium workpiece subjected to friction stir processing in accordance with an embodiment of the invention.

FIG. 2 is a side sectional view of a thermally aged aluminum-scandium workpiece with a particulate coating subjected to friction stir processing in accordance with another embodiment of the invention.

FIG. 3 is a photograph of a section of an Al-Mg-Zn-Sc cast billet which was subjected to three passes with a friction stir welding tool in accordance with an embodiment of the present invention.

FIG. 4 is a section taken through the friction stirred billet of FIG. 3, showing the refined grain structure after three passes with stir welding tool in high strength Al-Zn-Mg-Sc-Zr alloy. In this example the tool only penetrated about ¾ of the thickness of the cross section of the casting. Essentially no grain growth or recrystallization occurred in the regions of passes one and two.

FIGS. 5-8 are photomicrographs from different regions of the friction stirred billet of FIG. 3, illustrating the cast microstructure in the high strength Al-Zn-Mg-Sc-Zr alloy. The friction stirred billet includes refined grain size in the first FSP pass (FIG. 5), refined grain size in the last FSP pass (FIG. 6), coarse annealed/homogenized grains in the thermo-mechanically affected zone (TMAZ) (FIG. 7), and relatively large grains in the as-cast microstructure (FIG. 8).

FIGS. 9 and 10 are photomicrographs of a portion of the friction stirred zone and TMAZ from the friction stirred billet of FIG. 3. FIG. 9 shows the friction stirred workpiece before it was heat treated and aged, while FIG. 10 shows the friction stirred workpiece after it was heat treated and aged. By comparing FIGS. 9 and 10, it can be seen that essentially no grain growth or recrystallization occurred as a result of the heat treatment and aging.

### DETAILED DESCRIPTION

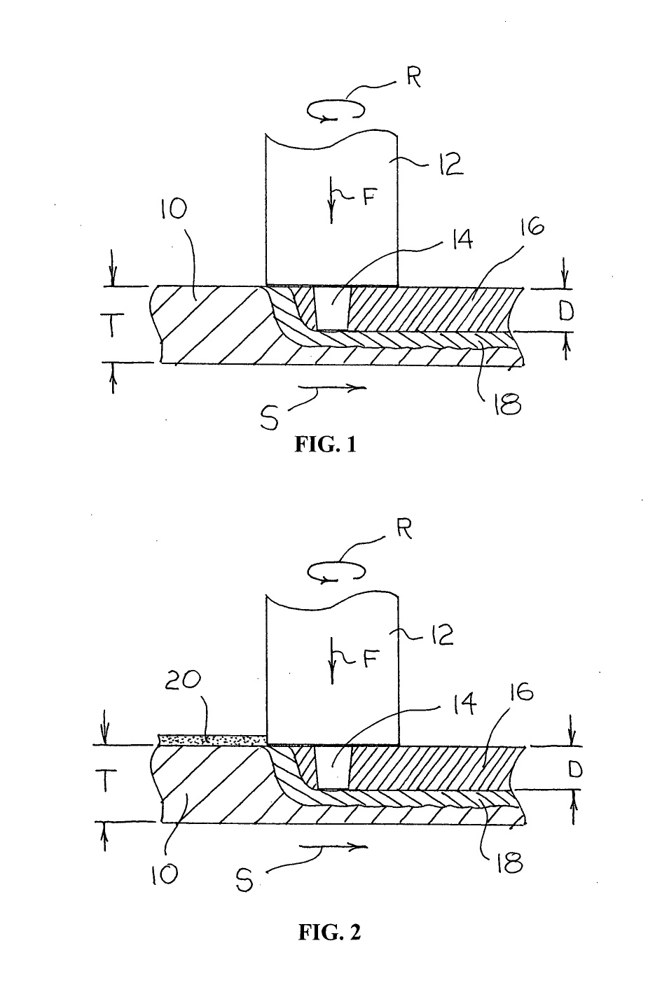

FIG. 1 schematically illustrates a friction stir process in accordance with an embodiment of the present invention. A thermally aged aluminum-scandium workpiece 10 in the form a plate having a thickness T is positioned below a rotating spindle 12 having a rotating pin 14 mounted therein. Rotation of the spindle 12 and pin 14 are illustrated by the arrow R in FIG. 1. The downward force of the spindle 12 against the workpiece 10 in shown by the arrow F in FIG. 1. As the spindle 12 and pin 14 rotate, the workpiece 10 is moved at a translation speed S underneath the spindel 12. Although the rotating spindle 12 is maintained in a stationary position and the workpiece 10 is moved with respect to the stationary rotating spindle 12 in the embodiment shown in FIG. 1, the workpiece 10 may alternatively be held in a stationary position, while the rotating spindle 12 is translated across its surface. The depth of penetration of the pin 14 below the surface of the workpiece 10 results in a friction stirred zone 16 having a depth D in the portion of the workpiece 10 that has been processed. The depth D may be controlled to any desired level, and may extend partially or entirely through the thickness T of the workpiece 10. In addition to the friction stirred zone 16, a thermo-mechanical affected zone 18 is also produced adjacent to the friction stirred zone 16. As more fully described below, the microstructures of the friction stirred zone 16 and TMAZ 18 are controlled in accordance with the present invention in order to provide desired properties of the friction stir processed workpiece 10.

FIG. 2 schematically illustrates a friction stir process similar to that illustrated in FIG. 1, with the addition of a coating 20 applied to the surface of the workpiece 10. The coating 20 may comprise various materials such as particles or alloying metals that are incorporated in or on the friction stir processed workpiece 10.

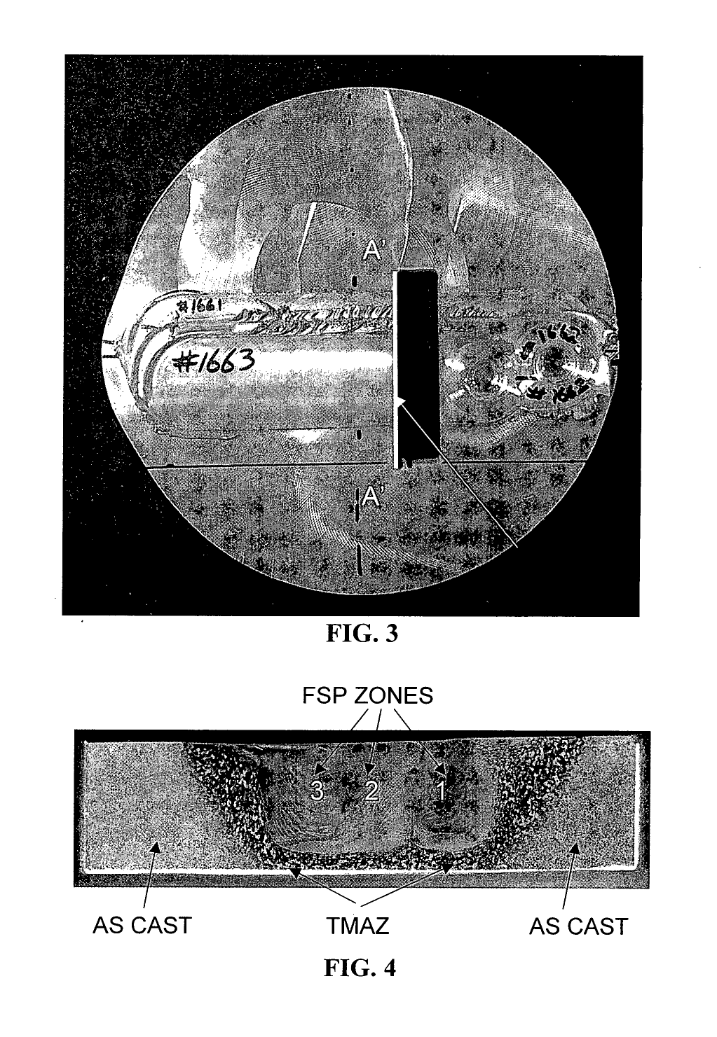

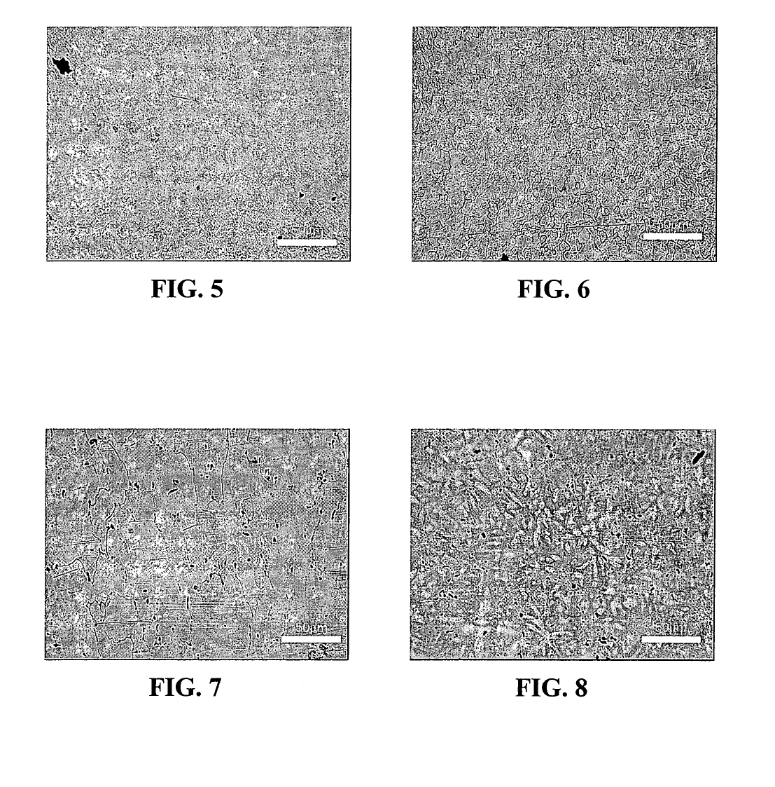

FIGS. 3-8 illustrate the microstructure of a cast Al-5.25Zn-2Mg-0.2Mn-0.12Sc-0.14Zr-0.01Ti billet cut into a one-inch thick disk that was thermally aged at 870° F. (466° C.) for 16 hours and then friction stir processed using a 0.5 inch diameter pin rotated R at about 500 rpm at a penetration depth D of about 0.75 inch with a traverse speed S of about 10 inches per minute and a downward force F of about 12,000 pounds. The friction stirred zones exhibited significantly reduced grain sizes and were unrecrystallized.

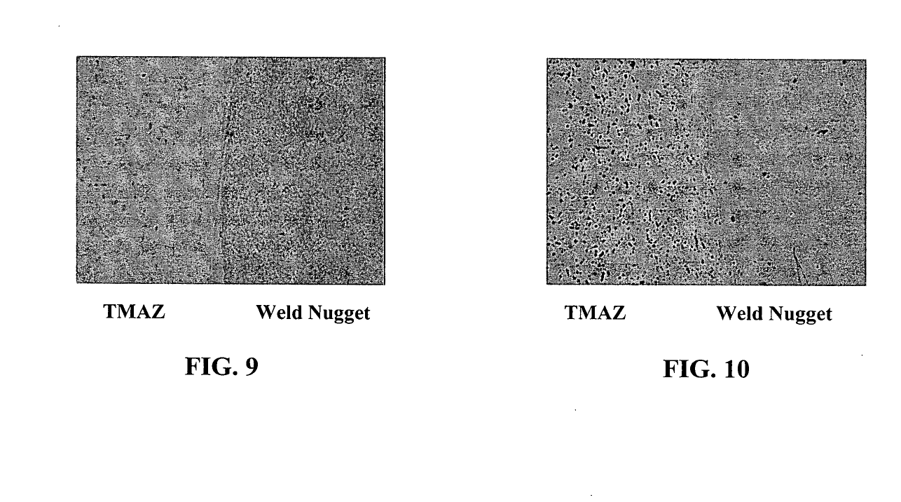

FIGS. 9 and 10 show portions of the friction stirred zone and TMAZ from the friction stirred billet of FIG. 3. FIG. 9 shows the friction stirred workpiece before it was heat treated and aged. FIG. 10 shows the friction stirred workpiece after it was solution heat treated for 45 minutes at 875° F. (468° C.), water quenched, and aged for 24 hours at 250° F. (121° C.). By comparing FIGS. 9 and 10, it can be seen that essentially no grain growth or recrystallization occurred as a result of the heat treatment and aging.

The addition of scandium to aluminum alloys in accordance with the present invention reduces recrystallization in the matrix during friction stir processing. Very high local deformation and elevated temperatures occur in the microstructure during friction stir processing of aluminum alloys. This results in a dramatic refinement of the microstructure in the so-called nugget region. These conditions can also cause recrystallization and abnormal grain growth in regions adjacent to the nugget. Thus, when multiple passes are used to process an alloy subsequent passes can cause recrystallization in the nugget regions from the previous passes. This recrystallization and grain growth can be reduced or eliminated by adding scandium to the alloy. Scandium contents from about 0.01 to about 2 percent by weight may be added to reduce recrystallization and grain growth. Typical levels of from about 0.01 to about 0.18 or 0.2 percent by weight may be added to control recrystallization and grain growth. For example, a Sc level of from about 0.05 to about 0.14 percent by weight may be used to prevent recrystallization and grain growth.

In accordance with the present invention, before friction stir processing, the aluminum alloys containing scandium are given a relatively high-temperature thermal aging treatment to precipitate Al-Sc phases. These phases reduce or eliminate recrystallization in the matrix during friction stir processing. In the as-cast condition, scandium atoms remain in solution at levels that are much higher than equilibrium, e.g., the matrix is supersaturated with Sc. Thermal aging at elevated temperatures results in precipitation of scandium-containing phases such as Al₃Sc. Once formed these equilibrium scandium-containing precipitates remain stable at temperatures up to the melting point. Thermal aging should be done at temperature from about 250° C. to about 500° C. A typical temperature range for thermal aging is from about 250° C. to about 350° C., with a temperature of about 300° C. being particularly suitable for precipitation of the Al-Sc phase. After thermal aging, the casting is homogenized to reduce localized segregation of solute in the grain structure.

After the friction stirring process, the resultant workpiece may be heat treated and aged to improve mechanical or other properties of the Al alloy while substantially eliminating grain growth and/or recrystallization. This aging step is performed at relatively low temperatures in comparison with the initial thermal aging that is performed prior to the friction stir processing step. Heat treatment and aging processes conventionally used with 2XXX, 5XXX, 6XXX, 7XXX, and Al-Li alloys and the like may be utilized. For example, solution heat treatment at temperatures of from about 425 to 550° C. may be used, followed by quenching and aging at temperatures of from about 25° C. to about 175° C., typically 100 to 150° C.

In accordance with an embodiment of the present invention, the stir process may be used to refine the grain size in DC cast aluminum-scandium alloys to fabricate panels that can be used as lightweight high strength armor. This fine grained microstructure resists penetration and spalling when impacted with ballistic projectiles or fragments. After stir processing the panels can be aged to a peak strength or solutionized, quenched and aged to increase strength. Panels can be joined together using the friction stir welding process to form a structure with enhanced properties over a conventionally welded structure.

The present stir process may also be used to modify the grain structure in specific regions on a net shaped cast part. This approach is used to develop a wrought grain structure in net shaped castings. In this example, a golf club driver type head is fabricated from a high strength Al-Zn-Mg-Sc alloy using a net shaped casting process, e.g., investment casting. The face portion of net shaped golf club head that is designed to strike the ball is stir processed. The stir processing converts this region from a low strength coarse grained segregated cast microstructure to an ultra fine grained wrought type structure. Similar enhancements of other golf club types can be produced through this technique, such as putter faces with enhanced hardness, and wedges with enhanced grip.

In accordance with an embodiment of the present invention, powder may be applied to the surface of a cast or wrought aluminum-scandium alloy. A ceramic powder of high compressive strength is applied to an aluminum surface, e.g., through conventional surface coating processes such as thermal spray, high velocity oxy-fuel (HVOF) and the like. The friction stir process is then applied to the structure, whipping the ceramic particles into the structure to a desired depth and distribution. The resulting layer will exhibit significant wear resistance over the bulk aluminum alloy.

Whereas particular embodiments of this invention have been described above for purposes of illustration, it will be evident to those skilled in the art that numerous variations of the details of the present invention may be made without departing from the invention.

1. A method of treating an Al alloy substrate, the method comprising:
thermally aging an Al alloy substrate comprising Sc to form Sc-containing precipitates in the Al alloy substrate;
plunging a rotating tool into a surface of the Al alloy substrate and translating the Al alloy substrate with respect to the rotating tool to produce a friction stirred zone over at least a portion of the surface of the Al alloy substrate; and
heat treating and aging the Al alloy substrate.

2. The method of claim 1, wherein the thermal aging is performed at a temperature of from about 250 to about 500° C.

3. The method of claim 1, wherein the heat treating is performed at a temperature of from about 425 to about 550° C.

4. The method of claim 1, wherein the aging is performed at a temperature of from about 25 to about 175° C.

5. The method of claim 1, wherein the rotating tool is plunged partially through a thickness of the Al alloy substrate.

6. The method of claim 1, wherein the rotating tool is plunged entirely through a thickness of the Al alloy substrate.

7. The method of claim 1, wherein the translating of the Al alloy substrate with respect to the rotating tool is done by maintaining the rotating tool in a stationary position and moving the Al alloy substrate.

8. The method of claim 1, wherein the translating of the Al alloy substrate with respect to the rotating tool is done by maintaining the Al alloy substrate in a stationary position and moving the rotating tool.

9. The method of claim 1, wherein the Sc comprises from about 0.01 to about 2 weight percent of the Al alloy substrate.

10. The method of claim 9, wherein the Sc comprises from about 0.05 to about 0.2 weight percent.

11. The method of claim 1, wherein the Sc-containing precipitates comprise Al₃Sc.

12. The method of claim 1, wherein the Al alloy substrate further comprises Zr, Cr, Mn, Ti, Hf, V, Nb and/or B in a total amount up to about 2 weight percent.

13. The method of claim 1, wherein the Al alloy substrate is provided in the form of a casting.

14. The method of claim 1, wherein the Al alloy substrate is provided in the form of a wrought product.

15. A method of treating a cast Al alloy substrate, the method comprising:
providing a cast Al alloy substrate comprising Sc-containing precipitates therein;
plunging a rotating tool into a surface of the Al alloy substrate and translating the Al alloy substrate with respect to the rotating tool to produce a friction stirred zone over at least a portion of the surface of the Al alloy substrate; and
heat treating and aging the Al alloy substrate.

16. An aluminum-scandium alloy substrate comprising a thermally aged and friction stirred zone over at least a portion of a surface of the aluminum-scandium alloy substrate.
